(19) United States
(12) Patent Application Publication
(10) Pub. No.: US 2025/0362233 A1
(43) Pub. Date: Nov. 27, 2025

(54) SYSTEM AND METHOD FOR RAPID AND LABEL-FREE IMAGING OF BIOLOGICAL TISSUES BASED ON MICROSCOPY WITH ULTRAVIOLET SINGLE-PLANE ILLUMINATION

(71) Applicant: The Hong Kong University of Science and Technology, Hong Kong (CN)

(72) Inventors: Tsz Wai WONG, Hong Kong (CN); Yan ZHANG, Hong Kong (CN); Bingxin HUANG, Hong Kong (CN); Tung Kei LO, Hong Kong (CN)

(21) Appl. No.: 19/107,222

(22) PCT Filed: Jul. 4, 2023
(86) PCT No.: PCT/CN2023/105629

§ 371 Date: Feb. 27, 2025

Related U.S. Application Data
(60) Provisional application No. 63/417,682, filed on Oct. 19, 2022.

(51) Int. Cl. G01N 21/64; G01N 15/10; G01N 15/1433; G01N 15/1434; G02B 21/00

(52) U.S. Cl. CPC G01N 21/6486; G01N 15/1433; G01N 15/1434; G01N 21/6458; G02B 21/0076; G01N 2015/1006

(57) ABSTRACT

A rapid, label-free, non-destructive imaging method and system (100) for unprocessed biological tissue, which is based on microscopy with ultraviolet single plane illumination (MUSI). The present system (100) or method employs a selective two-axis planar illumination configuration, which decouples the illumination from the detection path, and utilize the intrinsic fluorescence of certain endogenous fluorophores from biological tissues as a natural source compared to deep UV illumination sources. In contrast to images produced by clinical standard methods (i.e. H&E staining of formalin-fixed and paraffin-embedded tissues), images generated by MUSI reveal comparable or even better diagnostic features, providing clinicians, pathologists, and surgeons with greater potential as post-operative and intra-operative diagnostic tools.

### CROSS-REFERENCE TO RELATED APPLICATION

This application claims priority from the U.S. provisional patent application Ser. No. 63/417,682 filed Oct. 19, 2022, the disclosure of which is incorporated herein by reference in its entirety.

### TECHNICAL FIELD

The present invention relates to a system and method for rapid, label-free and non-destructive imaging of unprocessed biological tissues based on microscopy with ultraviolet single-plane illumination (MUSI).

### BACKGROUND

Histopathology has remained the gold standard for surgical margin assessment (SMA) for decades. However, routine pathological examination based on formalin-fixed and paraffin-embedded (FFPE) tissues is laborious and time-consuming, failing to guide surgeons intraoperatively. Although frozen section can serve as a rapid alternative to FFPE, it still requires a turnaround time of 20 to 30 minutes during surgery. Besides, the frozen section is subjected to limited sampling of resection margins and freezing artifacts in adipose tissues, which will affect the histopathological interpretation and diagnostic accuracy.

Recent advances in optical microscopy enable rapid and non-destructive imaging of fresh resection tissues, holding great promise to streamline the current clinical practice in FFPE histology. Imaging modalities based on exogenous fluorophores such as fluorescence confocal microscopy, light-sheet microscopy, structured illumination microscopy and microscopy with ultraviolet (UV) surface excitation can provide sufficient sampling of large resection margins within a point-of-care timeframe, providing highly specific cellular features for diagnosis. However, they pose a threat to intraoperative surgical procedures as some new fluorescent contrast agents might introduce toxicities to patients. Besides, the staining process may interfere with the subsequent molecular assays such as fluorescence in situ hybridization and DNA/RNA sequencing.

Thus, imaging techniques based on intrinsic contrast mechanisms are more favorable in modern clinical settings. For instance, in the area of ophthalmology and dermatology, optical coherent tomography (OCT) and reflectance confocal microscopy (RCM) have been used and successfully translated due to the nature of deep penetration and non-invasiveness. However, the cellular contents provided by these reflectance-based methods are relatively limited within internal organs. Besides, photoacoustic microscopy (PAM) can spectrally probe different molecular targets with intrinsic absorption contrast, showing promising results in breast cancer screening and vascular imaging. Furthermore, nonlinear microscopy (NLM), such as coherent Raman scattering, multiphoton absorption, and second/third harmonic generation, can achieve high-resolution and label-free visualization of a variety of biological processes in an unperturbed and non-destructive way, showing wide applications in oncological research such as tumor infiltration and growth. However, these methods still face challenges in screening large surgical specimens within a short diagnostic timeframe due to the requirement of sequential beam scanning. Lasers used in PAM or NLM are usually bulky and expensive, thereby increasing the facility requirement and cost.

A recently proposed method, computational high-throughput autofluorescence microscopy by pattern illumination (CHAMP), enables rapid and label-free histological imaging of thick and unprocessed tissues with a micrometer-scale resolution, particularly favoring the applications of intraoperative SMA where immediate feedback should be provided to surgeons for optimal adjuvant treatment. However, the depth-of-field (DOF) of CHAMP is restricted within 80 μm, which is not sufficient to accommodate rough resection tissues with large surface irregularities, causing the surgical margins to come in and out of focus during imaging. Besides, CHAMP achieves optical sectioning by leveraging the shallow penetration depth of the deep-UV light, which can present large variations in different types of tissues, thus the CHAMP images could have deviations from the conventional slide-based FFPE histology.

A need therefore exists for an improved method and system that at least diminish or eliminate the disadvantages and problems described above.

### SUMMARY OF INVENTION

Accordingly, a first aspect of the present invention provides an imaging system for histological analysis of biological tissues based on microscopy with an ultraviolet single-plane illumination (MUSI). The present MUSI takes advantages of intrinsic fluorescence from biological tissues as a source of contrast with a deep-UV excitation and incorporates a dual-axis configuration to decouple illumination from detection paths for overcoming inherent trade-off between long DOF and high spatial resolution.

Different from some non-destructive optical imaging techniques such as microscopy with ultraviolet surface excitation (MUSE), structured illumination microscopy (SIM) and light-sheet microscopy (LIM), MUSI does not require fluorescence labeling before imaging. Although some label-free microscopy techniques such as ultraviolet photoacoustic microscopy (UV-PAM) and nonlinear microscopy (NLM) including multiphoton microscopy (MPM), stimulated Raman scattering microscopy (SRS), and second/third harmonic generation (S/THG) can different intrinsic molecular/cellular responses to the illuminations such as absorption-induced thermoelastic expansion (by UV-PAM), intrinsic autofluorescence (by MPM), molecular vibration (by SRS), and non-centrosymmetric orientation (by SHG) in order to achieve cell phenotyping/classification, these scanning-based techniques have limited imaging throughput. Although reflectance-based imaging techniques such as full-field optical coherence tomography (FF-OCT), reflectance confocal microscopy (RCM), and dark-field reflectance ultraviolet microscopy (DRUM) can enable output of rapid and label-free images while detecting back-reflected light from structures with different refractive indices, important diagnostic features revealed by these techniques may present obvious difference from the clinical standard method due to limited contrast, resolution, and signal-to-noise ratio. In particular, DRUM relies on sensing diffuse reflectance whereas the present invention based on MUSI relies on intrinsic absorption of the light and uses fluorescence from the specimen as contrast. DRUM also has a shorter depth-of-filed (DOF) than that of MUSI, so that MUSI is particularly suitable for scanning of irregular tissue surfaces. In addition, the optical sectioning strength of DRUM is tissue-dependent whereas MUSI has no such constrain, such that MUSI could show robust performance in different types of tissue. The present invention is also applicable to both ex vivo and in vivo imaging of target tissue whereas DRUM can only be used for ex vivo imaging.

Therefore, in the first aspect, the present imaging system includes:
a movable specimen-holding platform including a specimen holder and a liquid holder, the liquid holder having at least one surface incorporated with a prism-like structure;
a deep-UV excitation source providing deep-UV illuminations;
a first plurality of optical elements for generating a light sheet from the deep-UV illuminations provided by the deep-UV excitation source and directing the light sheet towards a bottom side of the specimen holder in order to illuminate on a bottom surface of the specimen at an incidence angle with respect to a vertical axis of the specimen holder or an optical axis of the deep-UV illuminations through one of lateral faces of the prism-like structure of the at least one surface of the liquid holder;
a second plurality of optical elements for receiving light emissions including emitted fluorescence signals from the specimen under an excitation by the light sheet at a detection angle with respect to the vertical axis of the specimen holder; and
an optical detection unit for detecting and processing the received light emissions by the second plurality of optical elements,
wherein the incidence angle and the detection angle are substantially identical in magnitude and a beam path of the light sheet is substantially perpendicular (or orthogonal) to that of the light emissions from the specimen.

In certain embodiments, the movable specimen-holding platform is connected to a three-dimensional (3D) translational stage.

In certain embodiments, the specimen holder contains a membrane to support the sample.

In certain embodiments, the liquid in the liquid holder of the movable specimen-holding platform includes water or a mixture of water with UV-transparency.

In certain embodiments, the first plurality of optical elements includes at least a first filter, a pair of lenses, a slit aperture, and a cylindrical lens.

In certain embodiments, the first filter is a bandpass filter.

In certain embodiments, the pair of lenses is a pair of UV-grade convex lenses.

In certain embodiments, the slit aperture is an adjustable slit aperture.

In certain embodiments, the cylindrical lens is an UV cylindrical lens for generating a Gaussian light sheet.

In certain embodiments, the light sheet is illuminated on the bottom surface of the specimen through the prism-like structure of the liquid holder of the movable specimen-holding platform at an incidence angle of 45° against the vertical axis of the specimen holder with an average energy fluence in compliance with the safety UV radiation threshold regulated by American Conference of Governmental Industrial Hygienists (ACGIH®).

In certain embodiments, the liquid holder is disposed beneath the specimen holder in the movable specimen-holding platform.

In certain embodiments, the specimen is supported by a UV-transparent membrane being secured at a base of the specimen holder such that the light sheet can reach the bottom surface of the specimen held in the specimen holder

In certain embodiments, the UV-transparent membrane is made of a highly transparent thermoplastic including, but not limited to, polyethylene, or any UV transparent material.

In certain embodiments, the prism-like structure of the movable specimen-holding platform includes at least two UV-transparent windows disposed at two opposing lateral faces of the prism-like structure each allowing for the light sheet from the deep-UV excitation source to enter into or the light emissions including emitted fluorescence signals from the specimen after excitation by the light sheet to leave the movable specimen-holding platform.

In certain embodiments, the specimen is a biological tissue including normal and abnormal tissues such as freshly excised or intravital tissues from living organisms.

In certain embodiments, the biological tissue is abundant with endogenous fluorophores including, but not limited to, reduced nicotinamide adenine dinucleotide (NADH), structural proteins such as collagen and elastin, aromatic amino acids such as tryptophan and tyrosine, and heterocyclic compounds such as flavins and lipofuscin.

In certain embodiments, the second plurality of optical elements includes at least an UV objective lens, a second filter, and an infinity-corrected lens.

In certain embodiments, the UV objective lens is an achromatic UV objective lens.

In certain embodiments, the second filter is a long pass filter.

In certain embodiments, the infinity-corrected lens is an infinity-corrected tube lens.

In certain embodiments, the optical detection unit includes a plurality of CMOS image sensors.

In certain embodiments, the plurality of CMOS image sensors of the optical detection unit includes, but not limited to, scientific Complementary Metal-Oxide-Semiconductor (sCMOS) sensors.

In certain embodiments, the 3D translational stage provides at least two scanning directions for the movable specimen-holding platform to translate the specimen through the light sheet which passes through the UV-transparent membrane to reach the bottom surface of the specimen at a constant velocity along a first scanning direction. Besides the first scanning direction, the specimen can be further translated towards a secondary scanning direction along a lateral axis relative to the first scanning direction in order to obtain a surface topography of the specimen from its largest surface area.

A second aspect of the present invention provides a method for imaging a biological tissue in a label-free, unprocessed manner using the present imaging system according to the first aspect and various embodiments described herein to output histology-like images showing two-dimensional or three-dimensional profile of the biological tissue. The method includes at least the following steps:
(1a) placing the biological tissue into the specimen holder of the movable specimen-holding platform of the imaging system where a relatively flatter side of the biological tissue faces the UV-transparent membrane of the specimen holder;
(1b) immersing the specimen holder held with the biological tissue into the liquid holder of the movable specimen-holding platform filled with a liquid;
(1c) adjusting one or more of the first plurality of optical elements for directing light sheet generated thereby on the bottom surface of the specimen at an incidence angle of 45° with respect to the vertical axis of the specimen holder, or an incident beam path of the light sheet is substantially perpendicular to an UV-transparent window on one lateral face of the prism-like structure at the bottom of the liquid holder;
(1d) adjusting one or more of the second plurality of optical elements for receiving light emissions including fluorescence signals emitted from the specimen at a detection angle of 45° with respect to the vertical axis of the specimen holder or being orthogonal to the incident beam path of the light sheet;
(1e) initiating the deep-UV excitation source to generate UV illuminations towards the first plurality of optical elements followed by modulation of the UV illuminations by the first plurality of optical elements to generate and direct the light sheet towards a first spot of the specimen through one of the UV-transparent windows of the prism-like structure at the bottom of the liquid holder at the incidence angle of 45° with respect to the vertical axis of the specimen holder;
(1f) receiving the light emissions including emitted fluorescence signals from the specimen excited by the light sheet through the second plurality of optical elements;
(1g) detecting the received light emissions including emitted fluorescence signals from the second plurality of optical elements by the optical detection unit including the plurality of CMOS image sensors;
(1h) moving the movable specimen-holding platform driven by the 3D translational stage towards a primary scanning direction from the first spot to a subsequent spot of the specimen on the same plane and repeating the steps (1e) to (1g) in each of the subsequent spots until reaching the last spot on the same plane in the primary scanning direction, forming a first image stripe;
(1i) moving the movable specimen-holding platform towards a secondary scanning direction laterally relative to the first scanning direction and repeating steps (1e) to (1h) to form a subsequent image stripe adjacent to the first image stripe until the whole largest surface area of the biological tissue is scanned; and
(1j) processing the image data detected by the optical detection unit to reconstruct geometry of the biological tissue through an image processing module and outputting one or more images representing an overall geometry of the biological tissue after reconstruction.

In certain embodiments, the light sheet has a wavelength of about 266 nm.

In certain embodiments, the light sheet has a penetration depth from the bottom surface of the biological tissue of up to about 30 μm.

In certain embodiments, the specimen is translated through the light sheet at a constant velocity of 250 μm/s along the primary scanning direction, and images of the specimen along the primary scanning direction in each of the image stripes are recorded at 250 frames/s with a sampling pitch of 1 μm/pixel at the optical detection unit.

In certain embodiments, following formation of a first image stripe along the primary scanning direction, the movable specimen-holding platform is moved laterally relative to the primary scanning direction towards the secondary scanning direction such that the subsequent image stripe is formed along the primary scanning direction adjacent to the first image stripe, where the movement path of the movable specimen-holding platform for covering the whole largest surface area of the biological specimen is in serpentine or spiral centering pattern.

Optionally, the movement path of the movable specimen-holding platform for covering the whole largest surface area of the biological specimen can be in any other pattern, as long as the whole largest surface area of the biological specimen is imaged and subject to the freedom of movement of the 3D translational stage.

In certain embodiments, about 10% or less of overlapping features among each pair of adjacent image stripes is resulted.

In certain embodiments, the image processing module can be a standalone computer processor or network connecting to the present imaging system or be part of the present imaging system, which includes one or more image processing algorithms for processing a series of image stripes of detected image data.

In certain embodiments, distortion in raw images of the image stripes due to the detection angle unparallel to the vertical axis of the specimen holder can be corrected by one of the image processing algorithms.

In certain embodiments, at least surface features in the detected image data are extracted by the other image processing algorithm until all the image stripes are processed.

In certain embodiments, one of the image processing algorithms for correcting distortion in raw images of the image stripes due to the detection angle unparallel to the vertical axis of the specimen holder is written in MATLAB.

In certain embodiments, one of the image processing algorithms for surface feature extraction is an extended DOF algorithm

In certain embodiments, the extended DOF algorithm is introduced through a Fiji plugin to the MATLAB.

In certain embodiments, the other image processing algorithm for joining the extracted surface features of one image stripe to those of an adjacent image stripe is introduced by a Fiji grid-stitching plugin.

A third aspect of the present invention provides a method of imaging biological tissues or structure of a subject in vivo using the present imaging system. The method includes:
(2a) placing the subject under anesthesia onto an interior surface of a transparent base of the specimen holder with a posture such that a biological tissue of interest is disposed as proximal as possible to the UV transparent windows of the prism-like structure of the movable specimen-holding platform through which light beams of the light sheet enter into or those of the light emissions including emitted fluorescence signal from the specimen leave the specimen holder at an incidence angle or detection angle of 45° with respect to the vertical axis of the specimen holder;
(2b) adjusting one or more of the first plurality of optical elements such that the light sheet generated thereby illuminates on the bottom surface of the specimen at an incidence angle of 45° with respect to the vertical axis of the specimen holder;
(2c) adjusting one or more of the second plurality of optical elements such that the light emissions including fluorescence signals emitted from the specimen are detected at a detection angle of 45° with respect to the vertical axis of the specimen holder or being orthogonal to the incident beam path of the light sheet;
(2d) adjusting one or more of the second plurality of optical elements for receiving light emissions including fluorescence signals emitted from the specimen at a detection angle of 45° with respect to the vertical axis of the specimen holder or being orthogonal to the incident beam path of the light sheet;
(2e) initiating the deep-UV excitation source to generate UV illuminations towards the first plurality of optical elements followed by modulation of the UV illuminations by the first plurality of optical elements to generate and direct the light sheet towards a first spot of the specimen through one of the UV-transparent windows of the prism-like structure at the bottom of the liquid holder at the incidence angle of 45° with respect to the vertical axis of the specimen holder;
(2f) receiving the light emissions including emitted fluorescence signals from the specimen excited by the light sheet through the second plurality of optical elements;
(2g) detecting the received light emissions including emitted fluorescence signals from the second plurality of optical elements by the optical detection unit including the plurality of CMOS image sensors;
(2h) moving the movable specimen-holding platform driven by the 3D translational stage towards a primary scanning direction from the first spot to a subsequent spot of the specimen on the same plane and repeating the steps (2e) to (2g) in each of the subsequent spots until reaching the last spot on the same plane in the primary scanning direction, forming a first image stripe;
(2i) moving the movable specimen-holding platform towards a secondary scanning direction laterally relative to the first scanning direction and repeating steps (2e) to (2h) to form a subsequent image stripe adjacent to the first image stripe until the whole largest surface area of the biological tissue is scanned; and
(2j) processing the image data detected by the optical detection unit to reconstruct geometry of the biological tissue through an image processing module and outputting one or more images representing an overall geometry of the biological tissue after reconstruction.

In certain embodiments, the movable specimen-holding platform has an open-top configuration to allow the specimen with any size and thickness be conveniently loaded from top.

In certain embodiments, the subject includes human and non-human animals.

In certain embodiments, the biological tissues or structure include normal and abnormal tissues, either freshly excised or intact, and part of or the whole internal organ.

Other possible arrangements described in the second aspect which are applicable can be various embodiments of the method in the third aspect.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF DRAWINGS

The appended drawings, where like reference numerals refer to identical or functionally similar elements, contain figures of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIG. 1A schematically depicts the present system based on MUSI according to certain embodiments.

FIG. 1B schematically depicts the structure and working mechanism of the present system as shown in FIG. 1A.

FIG. 1C shows an example of image processing method for raw images of a tissue specimen acquired by the system of FIG. 1A.

FIG. 1D shows a resulting image from processing multiple image stripes of raw images and an image of extracted surface of the tissue specimen acquired by the image processing method depicted in FIG. 1C and according to certain embodiments.

FIG. 2A shows an image from side view of illumination of a light sheet generated by the present system according to certain embodiments.

FIG. 2B shows an intensity distribution along a lateral direction at the focus of the light sheet as shown in FIG. 2A.

FIG. 2C shows a distribution of beam radius along an axial direction at the focus of the light sheet as shown in FIG. 2A.

FIGS. 3A-3J show label-free ex vivo imaging of freshly excised mouse tissues by the present system according to certain embodiments, in which: FIG. 3A shows MUSI image of a fresh mouse liver, and inset at the bottom left shows a photograph of the specimen; FIG. 3B shows one of the magnified regions as shown in FIG. 3A and its corresponding H&E stained image; FIG. 3C shows another magnified region as shown in FIG. 3A and its H&E stained image; FIG. 3D shows distributions of nuclear features extracted from FIG. 3C, where Wilcoxon rank-sum testing is carried out across groups with n=50 for each distribution. The significance is defined as p*≤0.05 in all cases; FIG. 3E shows MUSI image of a fresh mouse brain, and inset at the bottom left shows a photograph of the specimen; FIG. 3F shows one of the magnified regions as shown in FIG. 3E and its corresponding H&E stained image; FIG. 3G shows another magnified region as shown in FIG. 3E and its H&E stained image; FIG. 3H shows MUSI image of a fresh mouse kidney, and inset at the bottom left shows a photograph of the specimen; FIG. 3I shows one of the magnified regions as shown in FIG. 3H and its corresponding H&E stained image; FIG. 3J shows another magnified region as shown in FIG. 3H and its H&E stained image, where the scale bar used in FIGS. 3A, 3E, and 3H is 1 mm; the scale bar used in FIGS. 3B, 3C, 3F, 3G, 3I and 3J is 100 μm; GL denotes granule layer; ML denotes molecular layer; WM denotes white matter.

FIGS. 4A-4B show label-free in vivo imaging of living intact mouse tissues by the present system according to certain embodiments, in which: FIG. 4A shows MUSI image of intravital brain tissue; FIG. 4B shows MUSI image of intravital kidney tissue.

FIG. 5 shows imaging of human lung adenocarcinoma tissues by the present system according to certain embodiments.

FIGS. 6A-6L show imaging of human lung adenocarcinoma tissues by the present system according to certain embodiments, in which: FIG. 6A shows MUSI and H&E-stained images of a lung specimen with acinar-predominant adenocarcinoma, and inset at the bottom left shows a photograph of the specimen; FIG. 6B shows one of the magnified regions as shown in FIG. 6A and its corresponding H&E stained image; FIG. 6C shows another magnified region as shown in FIG. 6A and its corresponding H&E stained image; FIG. 6D shows a further magnified region as shown in FIG. 6A and its corresponding H&E stained image; FIG. 6E shows MUSI and H&E-stained images of a lung specimen with papillary-predominant adenocarcinoma, and inset at the bottom left shows a photograph of the specimen; FIG. 6F shows one of the magnified regions as shown in FIG. 6E and its corresponding H&E stained image; FIG. 6G shows another magnified region as shown in FIG. 6E and its corresponding H&E stained image; FIG. 6H shows a further magnified region as shown in FIG. 6E and its corresponding H&E stained image; FIG. 6I shows MUSI and H&E-stained images of a lung specimen with micropapillary-predominant adenocarcinoma, and inset at the bottom left shows a photograph of the specimen; FIG. 6J shows one of the magnified regions as shown in FIG. 6I and its corresponding H&E stained image; FIG. 6K shows another magnified region as shown in FIG. 6I and its corresponding H&E stained image; FIG. 6L shows a further magnified region as shown in FIG. 6I and its corresponding H&E stained image, where the scale bar in FIGS. 6A, 6E and 6I is 1 mm; the scale bar in larger panels of FIGS. 6B-6D, 6F-6H, and 6J-6L is 100 μm; the scale bar in smaller panels of FIGS. 6B, 6C, 6F, and 6G is 50 μm; TN denotes tumor cell nuclei; LN denotes lymphocyte nuclei; FC denotes fibrovascular core; AS denotes alveolar space; MC denotes micropapillary cluster; AP denotes anthracotic pigment.

FIGS. 7A-7D show imaging of human skin tissue by the present system according to certain embodiments, in which: FIG. 7A shows MUSI and its corresponding H&E-stained images of the human skin tissue specimen; FIG. 7B shows one of the magnified regions as shown in FIG. 7A and its corresponding H&E stained image; FIG. 7C shows another magnified region as shown in FIG. 7A and its corresponding H&E stained image; FIG. 7D shows a further magnified region as shown in FIG. 7A and its corresponding H&E stained image, where the scale bar in FIG. 7A is 1 mm; the scale bar in FIGS. 7B-7D is 100 μm.

FIG. 8 is a flowchart summarizing the present imaging method for ex vivo and in vivo imaging of target tissues according to certain embodiments.

Skilled artisans will appreciate that elements in the figures are illustrated for simplicity and clarity and have not necessarily been depicted to scale.

### DETAILED DESCRIPTION OF THE INVENTION

It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

The present invention provides a rapid, label-free, non-destructive method and corresponding system for imaging unprocessed biological tissues ex vivo and even in vivo such that it can provide a real-time qualitative assessment means for medical practitioners intraoperatively to locate where and decide the extent of tissues to be removed, as compared to conventional clinical standard method, i.e., conventional histological assessment including H&E staining. The present invention also holds a great potential to be an assistive diagnostic tool for pathologists or clinicians to assess the histology of the biopsy in order to evaluate the disease prognosis of a subject, alongside the conventional FFPE approach.

The following examples provide certain implementation details of the present imaging method and corresponding system which should not be considered limiting the scope of the present invention.

### EXAMPLES

### (A) Configuration of Open-Top MUSI System and Imaging Parameters

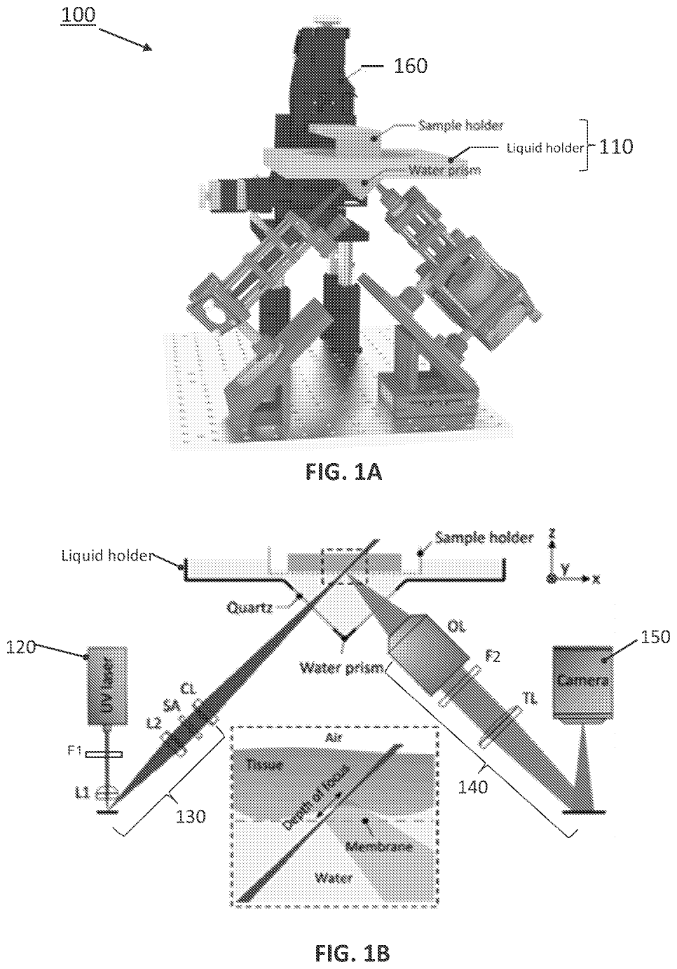

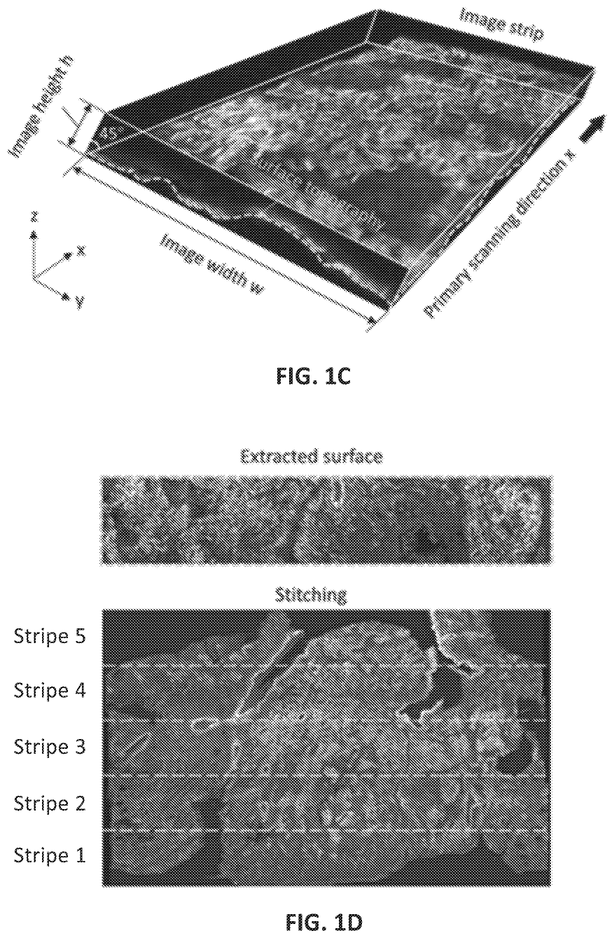

Turning to FIGS. 1A-1B, an open-top system of MUSI according to certain embodiments is schematically depicted. The system 100 includes a movable specimen-holding platform 110 including a sample (or specimen) holder and a liquid holder, where at the bottom side of the liquid holder is configured with a prism-like structure. Other polyhedral shapes allowing for incident and detection (including emission) light beams to perpendicularly enter into and leave the specimen-holding platform can be incorporated at the bottom of the liquid holder. As seen from the magnified view of the specimen-holding platform shown in FIG. 1B, on each of the two lateral faces of the prism-like structure, a UV-transparent quartz window is incorporated such that the incident beams of a light sheet originated from a deep-UV excitation source 120 and modulated by a first plurality of optical elements 130 to enter into the liquid holder of the specimen-holding platform in order to reach the tissues of interest held at the sample holder and the light emissions including fluorescence signals emitted by the tissues under an excitation by the incident beams of the light sheet originated from the deep-UV excitation source 120 to leave the liquid holder and subsequently be received by a second plurality of optical elements 140. The liquid-filled prism-like structure is configured to be disposed beneath or partially be the base of the specimen holder for mitigating imaging aberrations induced by the incidence angle of the incidence light beams from the light sheet and the detection of the light emissions including emitted fluorescence signals at the air-tissue-specimen holder interface (as shown in dotted inset in FIG. 1B). To provide design freedom of the prism-like structure, 3D printing may be used according to certain embodiments. Other conventional methods such as injection moulding could also be used to fabricate the polyhedral structure together with the liquid holder such that the prism-like structure is incorporated as part of the base or bottom face of the liquid holder.

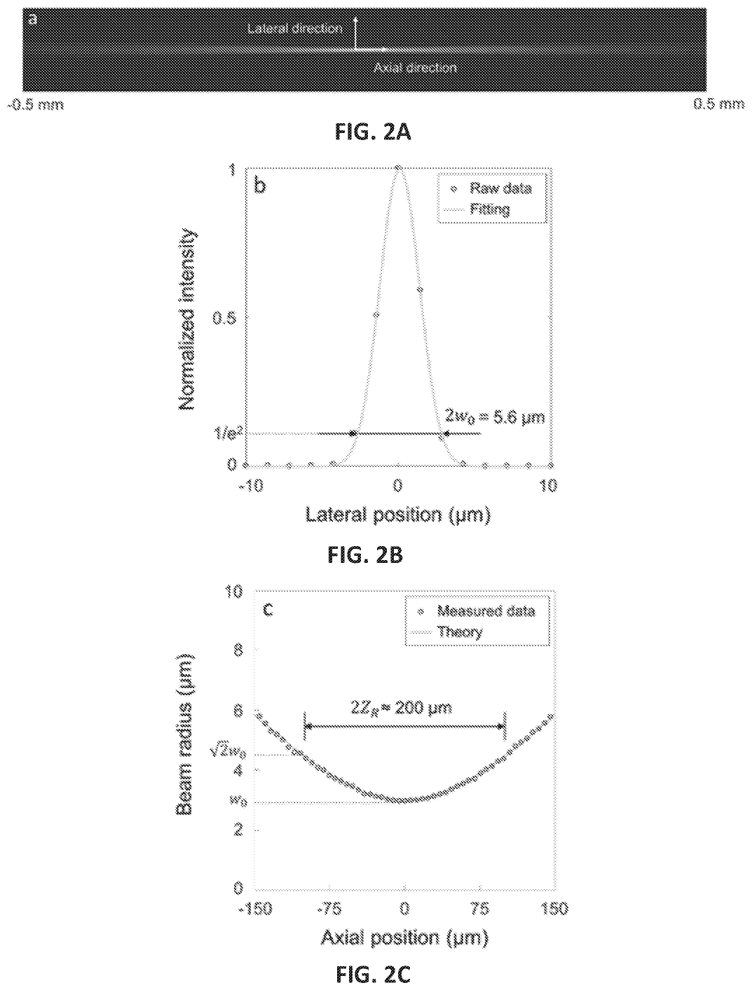

To allow the light sheet to reach the tissue specimen held at the specimen holder, the bottom of the specimen holder is made of a UV-transparent material, for example, a UV-transparent polyethylene membrane. In certain embodiments, the UV-transparent polyethylene membrane has a thickness of about 50 μm. In exemplary embodiments, the liquid is water or a mixture of water with an agent facilitating visualization of the tissue architecture under excitation by the light sheet originated from the deep-UV excitation source. In certain embodiments, the light sheet can be Gaussian light sheet. FIG. 2A shows an experimental profile of illuminated light sheet in a diluted solution of acridine orange, in which the light sheet generated by the present system has an illumination wavelength (λᵢₗₗᵤ) of about 266 nm and an effective numerical aperture (NA_{eff}) of about 0.03. FIGS. 2B-2C show the normalized intensity and beam radius distributions of the light sheet at the focus along the lateral and axial directions as shown in FIG. 2A. As seen in FIG. 2A, a 3-mm wide Gaussian light sheet with a waist radius (w₀) of 2.8 μm and a DOF (2Z_{R}) of ˜200 μm could be generated based on the following parameters and conditions: within the first plurality of optical elements, the UV illumination generated by deep-UV excitation source 120 is spectrally filtered by a bandpass filter F1 (FF01-300/SP-25, Semrock Inc.), and expanded by a pair of convex lenses, L1 and L2 (LA4647-UV and LA4874-UV, Thorlabs Inc.), where in between L1 and L2 there is a reflector configured to direct the UV illumination after being filtered by F1 and incident to L1 towards the subsequent optical elements including L2. The beam is then propagated through an adjustable slit aperture SA (VA100C, Thorlabs Inc.) after being expanded by L2, outputting a beam with a size of 3 mm×6 mm, which is subsequently focused by a UV cylindrical lens CL (LJ4395RM, f=100 mm, Thorlabs Inc.). Both incident and detection (including emission) beam paths focus perpendicularly through the two respective UV-transparent quartz windows (20 mm×20 mm) incorporated onto two lateral faces of the water prism. After passing a first UV-transparent quartz window, the as-generated light sheet will be illuminated on the bottom surface of the specimen at a 45° incidence angle (with respect to a virtual vertical axis of the specimen holder) through the water prism with an average energy fluence of 2 mJ/cm², which is within the safety UV radiation threshold regulated by ACGIH®. Therefore, adjustment of the first plurality of optical elements in view of the tissue specimen to result in a light sheet with an incidence angle of 45° through the water prism is suggested before illumination. The selection of a particular width for the light sheet accords with the field-of-view (FOV) of the present system. In the case of using the present system for in vivo imaging, illumination energy must be well controlled to ensure that the UV illumination is below the afore-mentioned threshold.

For the detection side, a second plurality of optical elements 140 is disposed at an orientation which allows for receiving a maximum light emission intensity from the tissue specimen. In this regard, an achromatic UV objective lens OL (LMU-5X-NUV, NA =0.12, Thorlabs Inc.) is disposed in parallel with the light path of the detection beam from the tissue specimen. A long pass filter F2 (BLP01-325R-25, Semrock Inc.) is disposed in the same orientation as that of the OL and at the rear end of the OL. The detection beam filtered by F2 is subsequently refocused by an infinity-corrected tube lens TL (TTL200-A, Thorlabs Inc.), and finally imaged by an sCMOS camera 150 (PCO edge 4.2, 2048×2048 pixels, PCO Inc.).

To enable scanning across the largest surface area of the tissue specimen, the specimen-holding platform 110 connects to a 3D translational stage 160 (L-509.20SD00, PI miCos GmbH) which allows at least two-axis translational movement of the specimen-holding platform 110. In certain embodiments, the largest surface area of the tissue specimen to be scanned can be up to 5 cm×5 cm. The specimen can be translated under exposure to a static light sheet at a constant velocity of 250 μm/s along the primary scanning direction, i.e., the x-axis in FIGS. 1B and 1C. Images can be recorded at 250 frames/s by the sCMOS camera 150 with a sampling pitch of 1 μm/pixel. The image height (h) can be adjusted according to the surface irregularities of the imaged specimen, with a maximum tolerance of ˜200 μm in the example shown in FIG. 1A. It is notable that the imaging speed in the case of ex vivo imaging can be increased by at least an order of magnitude with a high-power UV source that could reduce the exposure time to a few hundred microseconds or less as the intrinsic fluorescence signal is weaker under a relatively less powerful UV radiation/excitation source (only 2 mJ/cm² of UV radiation is used in this example). A higher framerate can be adopted by the sCMOS camera because a more powerful UV radiation can generate images with enough signal-to-noise ratio under short exposure time.

Following scanning the tissue specimen in the primary scanning direction (along the x-axis), the specimen is moved laterally along the y-axis as in FIG. 1C at an interval of 1.8 mm and is scanned in a serpentine pattern, e.g., vertical serpentine pattern. Multiple image stripes as in FIG. 1D will be obtained with about 10% overlapping between each pair of adjacent stripes when the multiple images stripes are stitched by a corresponding algorithm for stitching image stripes or grids with large field-of-views (FOVs). The raw images are stored at 16-bit depth and transferred through a CameraLink interface at a streaming rate of 2040 pixels (w)×200 pixels (h)×2 Byte×250 frames/s=0.2 GB/s to a local workstation equipped with a high-speed solid-state disk (970 EVO Plus, SAMSUNG Inc.). A self-designed software in LabVIEW is used to synchronize the acquired images and scanning area with respect to the movement of the 3D translational stage. By the foregoing settings, the MUSI can enable rapid imaging of freshly excised and unprocessed tissues (either ex vivo or in vivo) at a scanning speed of 0.5 mm²/s with an in-plane resolution of 1.5 μm, resulting in histology-like images with sufficient diagnostic features for medical practitioners, surgeons, and pathologists who may have to make intraoperative, post-operative, or therapeutic decision.

As depicted in FIG. 1C, raw images of the tissue specimen are taken initially at the primary scanning direction to form image stripe followed by scanning in the serpentine pattern to cover the largest surface area of the tissue specimen in order to generate multiple image stripes. Since the raw images are recorded at 45° incidence angle with respect to the tissue surface, tissue geometry reconstructed by the raw data volume loaded into MATLAB (Math Works, Inc) will be distorted. To correct this distortion, the raw data volume is sheared by 45° in x-z plane to create a trapezoidal data volume, as shown in FIG. 1C. Following correcting the distortion, an extended DOF algorithm is applied on the sheared data volume through a Fiji plugin for extracting an intact tissue surface of each image stripe (upper panel of FIG. 1D). Extracted surfaces of adjacent image stripes are then registered and stitched by a Fiji grid-stitching plugin to form a large-area tissue image (lower panel of FIG. 1D). In certain embodiments, shearing of raw images, correction of distortion due to shearing, extraction of intact surface from each image stripe as-generated, and registration and stitching of multiple adjacent image stripes for forming the large-area tissue image are all processed in a MATLAB-Fiji interface through micro scripts. The processing time for 1-cm² tissue surface is about 10 mins by using a workstation equipped with a Core i9-10980XE CPU@4.8GHz and 8×32 GB RAM, and 4 NVIDIA GEFORCE RTX 3090 GPUs. In certain embodiments, without a compromise of axial resolution, a longer DOF by using digitally scanned light-sheet systems with non-diffracting beams can be adopted to improve system tolerance for irregular tissue surfaces. In certain embodiments, certain components of the second plurality of optical elements at the detection side/arm of the present system can be changed such as fixed objectives can be replaced by switchable objectives with different resolving powers in order to cover imaging of tissue structures from sub-micron to macroscopic spatial scales.

To extract distributions of nuclear features in the tissue of interest, the tissue image can be segmented by a Fiji plugin, e.g., trainable Weka segmentation, and subsequently binarized and analyzed to acquire cross-sectional area and centroid of each cell nucleus. The shortest adjacent distance to a neighboring cell nucleus can be defined by the intercellular distance calculated based on the localized center positions of the cell nuclei from the extracted nuclear features. In certain embodiments, a deep learning neural network can be used to train a virtual staining model to generate pseudo-histochemically stained MUSI images in order to assist medical practitioners such as pathologists or surgeons to perform intraoperative or post-operative clinical assessment more efficiently and accurately.

### (B) Ex Vivo Imaging of Mouse Tissues

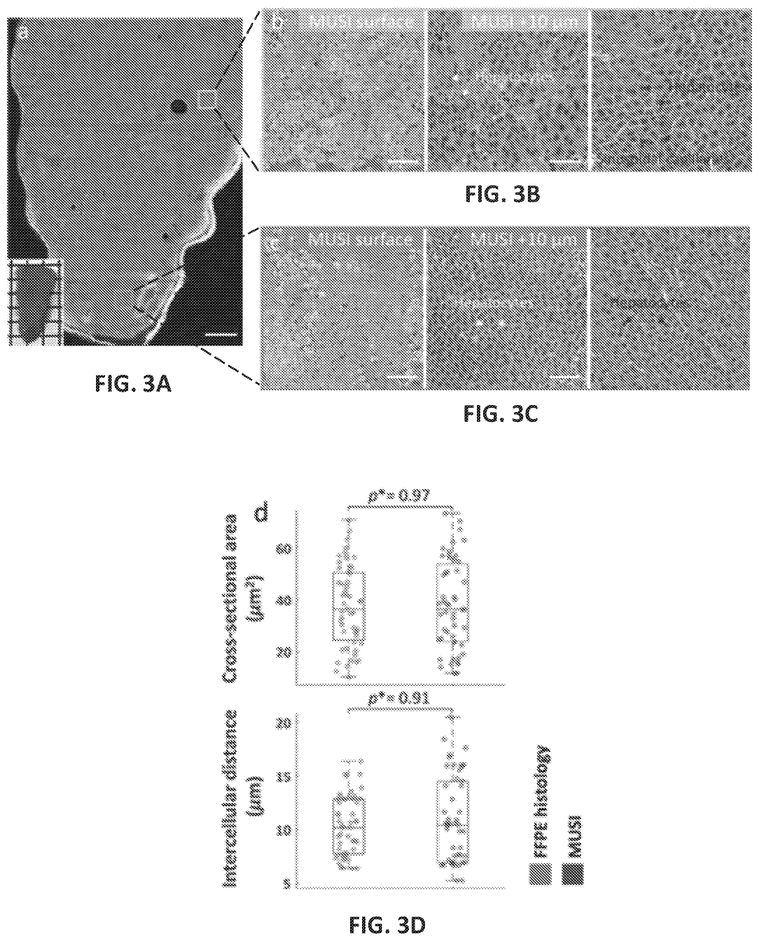

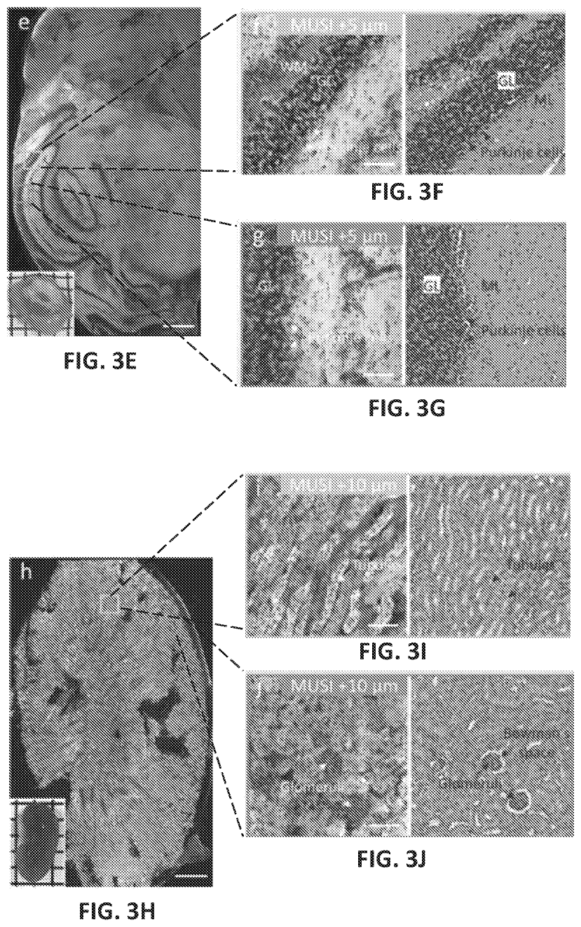

Turning to FIGS. 3A-3D, ex vivo imaging of internal organs from mice by the present system according to certain embodiments is compared with the tissues prepared and imaged by a conventional FFPE histology (hematoxylin and eosin (H&E) staining). Initially, internal organs such as liver, brain, and kidney were harvested immediately after the mice (C57BL/6 type) were sacrificed. After extraction, these organs were manually cut into 3- to 5-mm-thick tissue slabs for imaging. After imaging, all the specimens were histologically processed with a standard protocol to obtain the H&E-stained images for comparison.

As compared to the corresponding H&E-stained images (right panel in each of FIGS. 3B, 3C, 3E, 3F, 3I and 3J), the MUSI images of freshly excised mouse liver (FIGS. 3A-3C), brain (FIGS. 3E-3G) and kidney (FIGS. 3H-3J) tissue slabs each sectioned into 5-mm-thick demonstrate that the light sheet generated by the present system has a UV penetration depth between about 5 μm and about 30 μm, subject to tissue microarchitectures, degrees of tissue scattering, and density/distribution of certain endogenous fluorophores of different types/states of tissue. For instance, the UV penetrates differently in regions with densely-packed cell nuclei (e.g., primary tumors), lipid droplets (e.g., subcutaneous tissues), or large intercellular spaces (e.g., lung alveoli). For normal mouse tissues, the kidney and brain generally present higher intensity of intrinsic fluorescence than that of liver and lung tissues, and spleen tissues emit the least fluorescence among the five types of tissues after UV absorption; the intensity of certain metabolic enzymes, such as NADH and FAD, is generally higher in tumor than normal tissues, being a promising tumor-specific biomarker.

Notably, the FFPE thin slice is not able to exactly replicate the surface imaged by the MUSI due to different imaging thickness and tissue deformation during processing. However, the cellular morphology remains similar. The morphology of hepatocytes in mouse liver is better characterized at 10 μm below the tissue surface, showing a great similarity to the H&E-stained images with an only exception to the sinusoidal capillaries (FIG. 3B).

The nuclear features, such as cross-sectional areas and intercellular distances, are extracted from both MUSI and H&E-stained images for comparison. The statistical results (FIG. 3D), which are calculated from 50 hepatocytes selected from both MUSI and H&E-stained images in FIG. 3C, suggest that the cellular features extracted by MUSI agree fairly well with the clinical standard method.

In the mouse cerebellum, a clear interface between the molecular layer and granular layer with the intermediate Purkinje cells can be visualized in both MUSI and H&E-stained images (FIGS. 3F and 3G). Similarly, the features of renal tubules (FIG. 3I) and glomerular capsules (FIG. 3J) in mouse kidney can be well identified in the MUSI images, despite that the Bowman's space in renal corpuscles is less visible compared with the conventional FFPE histology.

### (C) In Vivo Imaging of Mouse Tissues

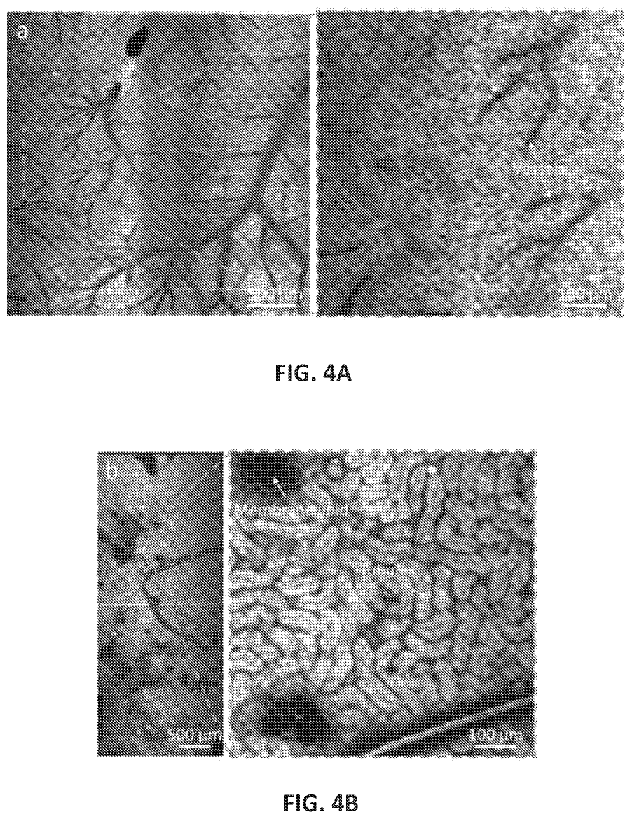

In this example, for kidney imaging, a small incision was made on the left side of the abdomen to expose the kidney, which was subsequently positioned and flattened against the holder for imaging from below. For brain imaging, the mouse slept on its back against the holder, and a 5-mm by 5-mm cranial window was made on the skull to expose the targeted brain area for imaging. FIGS. 4A and 4B show MUSI images of intravital brain tissue and intravital kidney tissue, respectively. From the enlarged views, structural details such as vessels, membrane lipid and tubules from corresponding tissues can be seen. Microvascular architecture and cell nuclei located at the surface of brain cortex in FIG. 4A would facilitate real-time detection of tumor margins during neurological surgeries; renal tubules could be easily identified with a high signal-to-noise ratio (FIG. 4B) due to highly-fluorescent cytoplasmic lipofuscin and urinary cast material. Although the penetration depth of the MUSI is limited due to strong tissue scattering, the present invention still provides a non-destructive and rapid assessment tool for intact tissues, in particular, in cases where biopsy might be contraindicated.

### (D) Ex Vivo Imaging of Human Tissues

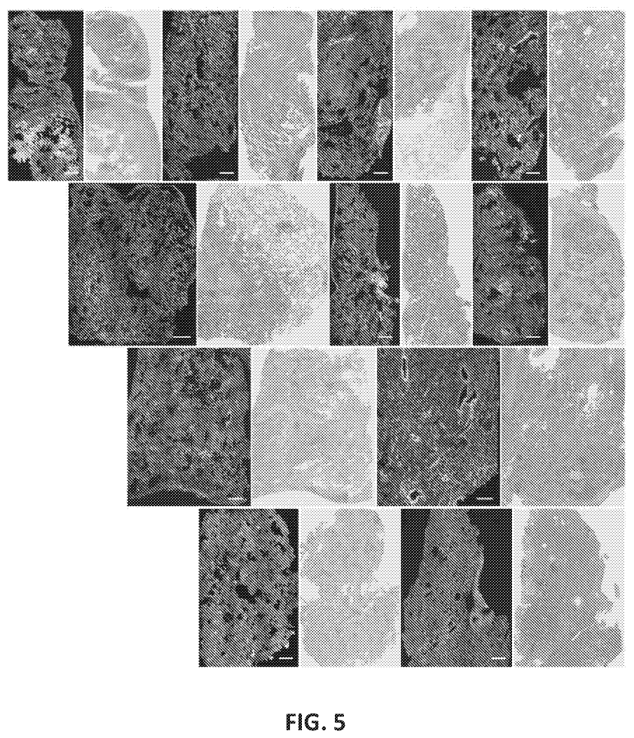

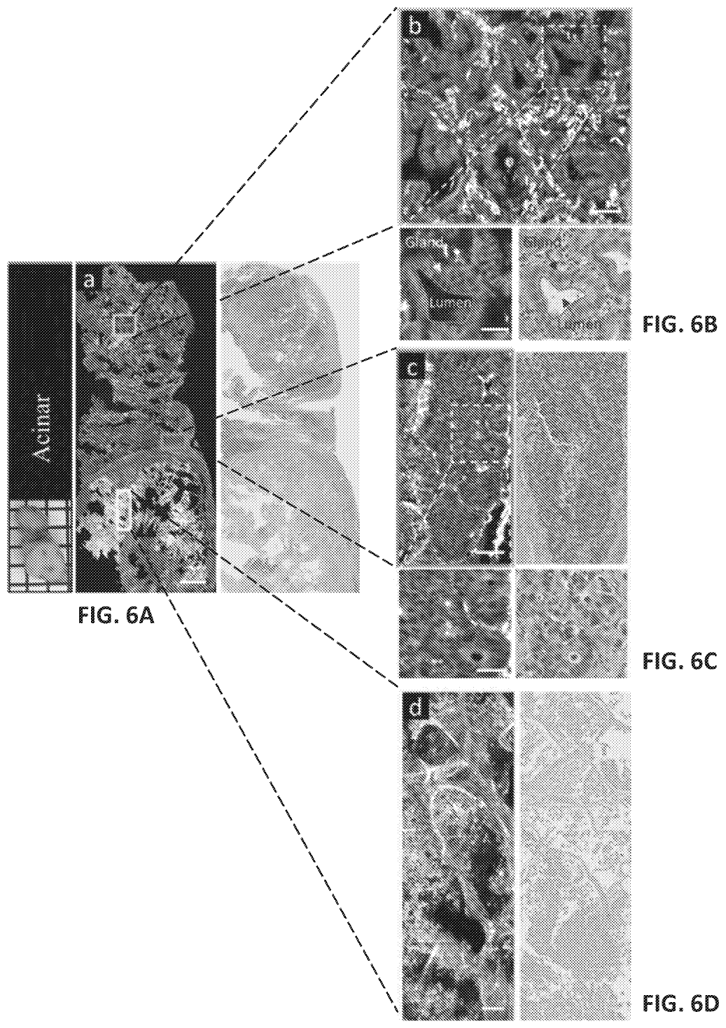

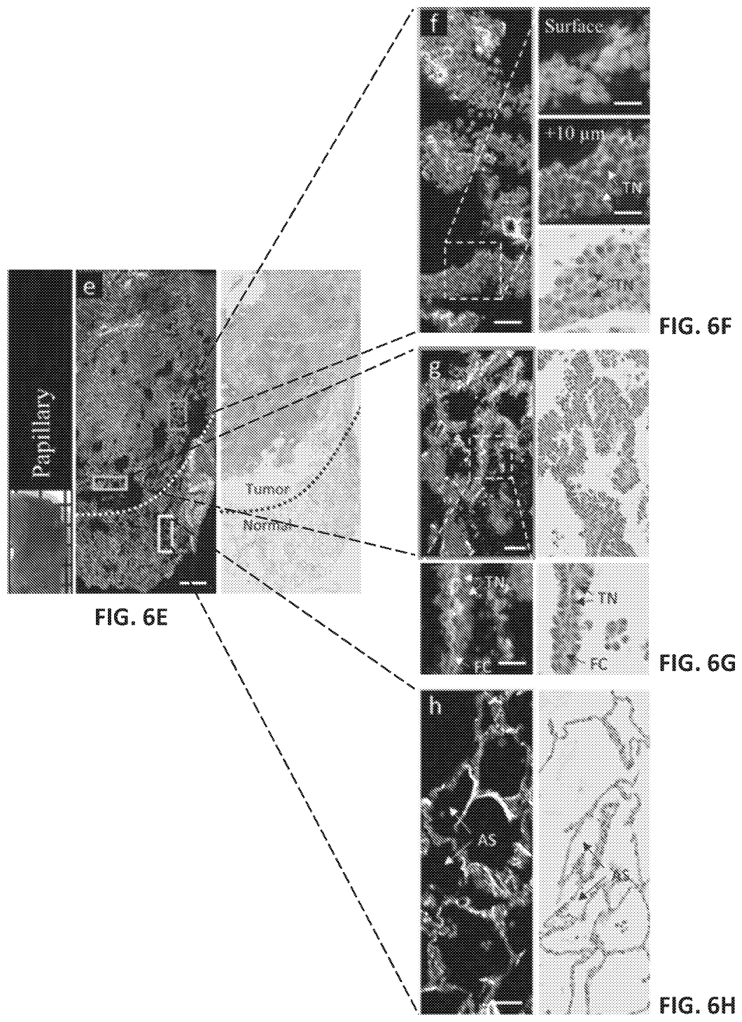

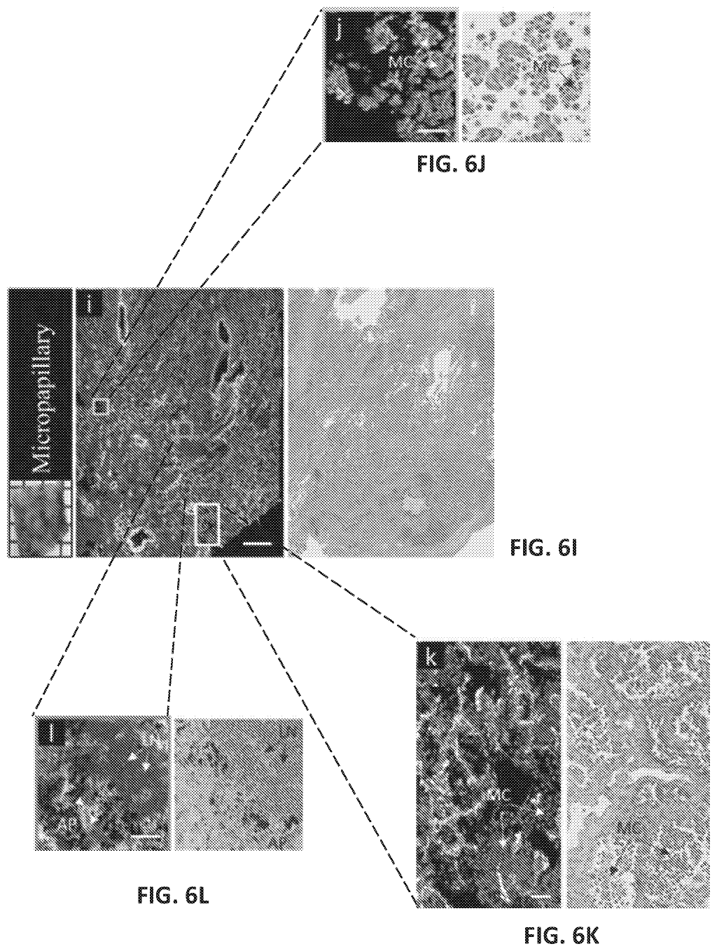

In this example, lung adenocarcinoma specimen is used to show capability of the present system MUSI. Adenocarcinoma is known to be the most common type of non-small cell lung cancer, which typically evolves from mucosal glands and occurs in the lung periphery. For excising freshly intact human lung cancer tissues, the specimens (n=11) were obtained from lung cancer patients who underwent curative lung cancer surgery at the Queen Mary Hospital with informed consent. Following lung lobectomy, the lung cancer tissues were cut from the resected lobe, imaged by the present system to obtain MUSI images, and subsequently formalin-fixed and subjected to standard imaging of H&E-stained slices for comparison. FIG. 5 shows a collection of representative MUSI images of human lung adenocarcinoma specimens generated by the present system and their corresponding H&E-stained images. Microstructures representing different subtypes of lung adenocarcinoma such as lepidic, acinar, papillary, micropapillary and solid could be seen from some of the MUSI images. FIGS. 6A-6D show a specimen with acinar-predominant adenocarcinoma, in which irregular-shaped glands in a fibrotic stroma can be easily identified by MUSI (FIGS. 6B and 6C). From FIG. 6C, it is observed that some glands are arranged as solid clusters of tumor cells with a less recognizable lumen. FIG. 6D shows that tissue fragments generated from cell disruption can be easily distinguished by the MUSI with a significantly increased intrinsic fluorescence.

In comparison, a papillary-predominant lung adenocarcinoma specimen is imaged by MUSI and the results are compared with clinical standard method, H&E-stained images, which are shown in FIGS. 6E-6H. A positive resection margin outlining a clear interface between normal and cancer regions is denoted by a dotted line in FIG. 6E. FIG. 6F shows that nuclei of tumor cells (TN) can be clearly characterized by the MUSI at a penetration depth of about 10 μm below the tissue specimen surface. FIG. 6G shows that a finger-like papillary architecture with tumor cells lining the surface of branching fibrovascular cores (FC) can be revealed in both MUSI and H&E-stained images. FIG. 6H shows that alveolar structures (AS) from normal region have normal morphology with large air spaces.

FIGS. 6I-6K show images of a pathologically confirmed micropapillary-predominant adenocarcinoma specimen by the MUSI and clinical standard method (H&E staining). Tumor cell clusters (MC) are found floating and detached within alveolar spaces with a lack of fibrovascular cores (FIGS. 6J and 6K). FIG. 6L shows a region with a large number of tumor-infiltrating lymphocytes (LN) and anthracotic pigments (AP), which are in good accordance with the H&E-stained images.

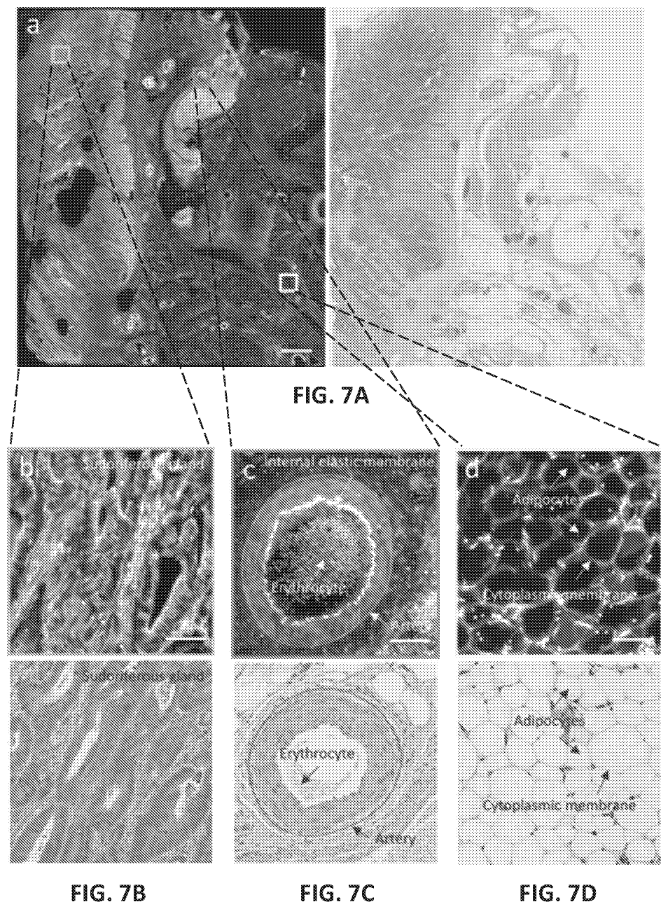

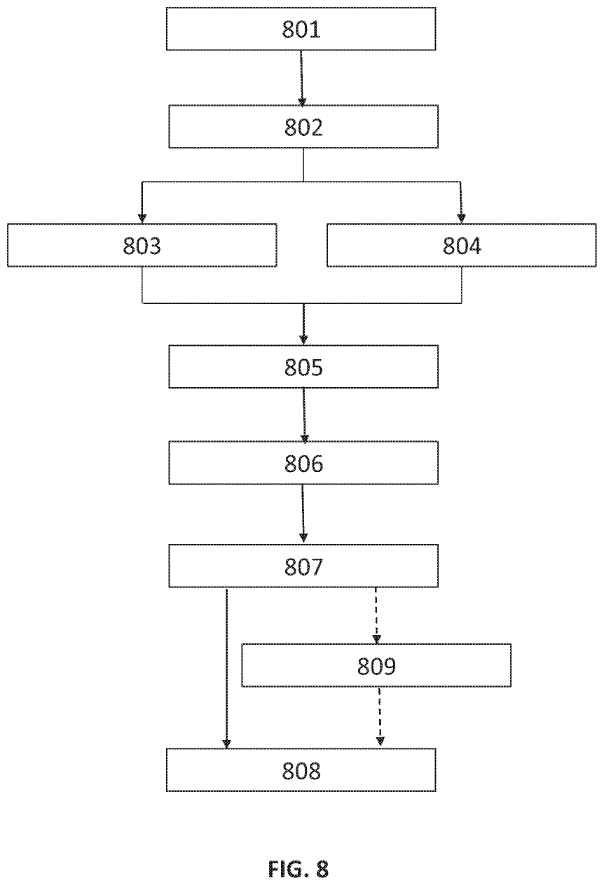

FIGS. 7A-7D show images of human skin by the MUSI and clinical standard method (H&E staining), in which microarchitectures such as sudoriferous gland (FIG. 7B), erythrocyte-filled arterial lumen (FIG. 7C) and adipose tissue (FIG. 7D) have been simultaneously characterized by the MUSI in a label-free and non-destructive manner, which is in a good accordance with the H&E-stained images again.

FIG. 8 summarizes the present imaging method. Initially, tissue (or subject) of interest is disposed on an interior surface of the base of the specimen holder where it is formed by a UV-transparent membrane. The specimen holder is immersed into a liquid holder of the movable specimen-holding platform (801). Preferably, a relatively flatter surface of the tissue of interest is disposed at the interior surface of the base of the specimen holder such that lesser light scattering effect is resulted. In certain embodiments, the tissue of interest is freshly excised from the subject for an ex vivo imaging by the MUSI or a surface of the tissue of interest is directly exposed to the light sheet for an in vivo imaging. In the embodiments which the in vivo imaging of the tissue of interest is performed, the specimen holder and liquid holder of the movable specimen-holding platform must be sterilized since the surface of the tissue of interest (e.g., a surface of an internal organ) and adjacent tissues thereof will be in direct contact with the interior surface of the base of the specimen holder. Thereafter, the specimen holder together with the tissue of interest is immersed into the liquid held in the liquid holder of the movable specimen-holding platform such that an interface between the surface of the tissue of interest and the UV-transparent membrane forming the base of the specimen holder. In certain embodiments, the liquid held in the liquid holder for ex vivo or in vivo imaging by the MUSI is selected from water or a mixture of water with UV-transparency. Other liquids with a suitable refractive index, e.g., liquid with a refractive index from 1.3 to 1.5, and high UV transmittance can be used for holding the tissue of interest and filling up the interface between the surface of the tissue of interest and the base of the specimen holder. As in FIG. 1B, the present system has an open-top light sheet configuration according to certain embodiments, where the light sheet is allowed to pass through the tissue of interest and exit the specimen holder from an open top of the movable specimen-holding platform. A long depth-of-field (DOF) of up to 200 μm from the surface of the tissue of interest (as in the inset of FIG. 1B) and a high spatial resolution of 1.5 μm (lateral) and 2.8 μm (axial) can be achieved by a selective, dual-axis planar illumination generated by the MUSI, enabling identification of subcellular diagnostic features of surgical tissues with large irregular surface. The dual-axis planar illumination configuration decouples the illumination from detection paths.

To ensure that the incidence and detection beam paths are orthogonal to each other and respectively sit under the specimen at 45° to vertical axis of the specimen holder, the first plurality of optical elements at an illumination arm of the present system including a reflector, a bandpass filter, a pair of convex lenses, an adjustable slit aperture, and an UV cylindrical lens is configured to direct the deep-UV excitation light beams generated by a nanosecond UV pulsed laser (wavelength at ˜266 nm) towards the bottom of the tissue specimen held at the specimen holder at said incidence angle and modulate the light beams to become a few millimeters-wide light sheet (803), for example, a 3-mm wide Gaussian light sheet with a waist radius (wo) of ˜2.8 μm and a DOF (2Z_{R}) of ˜200 μm (as in FIGS. 2A-2C) is generated. In certain embodiments, the light sheet as-generated is within the safety UV radiation threshold regulated by ACGIH®. The beam path of the light sheet is configured to be substantially perpendicular to one of the UV-transparent windows disposed at one of the lateral faces of a prism-like structure being partially the bottom of the liquid holder. The two UV-transparent windows on two opposing lateral faces thereof allows maximum transmission of the incident light beams of the light sheet and detection light beams of the light emissions including emitted fluorescence signals from the tissue specimen after excitation. In certain embodiments, the at least two UV-transparent windows are UV-transparent quartz windows. Preferably, the light sheet through the prism-like structure at the bottom of the liquid holder has an average energy fluence of 2 mJ/cm², which is sufficient to excite endogenous fluorophores in the tissue to emit fluorescence signals as a source of contrast with the deep-UV excitation.

Similarly, the second plurality of optical elements at the detection arm of the present system is adjusted accordingly to receive maximum level of detection (including emission) beams of fluorescence signal from the tissue specimen at a detection angle of 45° with respect to the vertical axis of the specimen holder (804), which exit the liquid holder through the other UV-transparent quartz window on a lateral face of the prism-like structure opposing to that for the incidence beams of the light sheet to pass through. The other UV-transparent quartz window is configured to be substantially perpendicular to the path of the detection beams such that the second plurality of optical elements receives the maximum emitted fluorescence signals from the tissue specimen. In certain embodiments, the second plurality of optical elements includes, but not limited to, an achromatic UV objective lens, a long pass filter, an infinity-corrected tube lens and a mirror. The received light emissions from the tissue specimen by the second plurality of optical elements are captured by an optical detection unit (805), for example, a sCMOS camera. The tissue specimen is translated by a connected 3D translational stage to the movable specimen-holding platform from one end to an opposing end of the tissue specimen in a primary scanning direction to obtain a first stripe of raw image data, followed by translation into a secondary scanning direction which is lateral to the primary scanning direction at a distance which a subsequent stripe of raw image data is to be obtained in the primary scanning direction adjacent to the first stripe of raw image data, until multiple stripes of raw image data are obtained to cover substantially the whole bottom surface of the tissue specimen (806). In certain embodiments, the multiple stripes of raw image data are obtained by scanning the bottom surface of the tissue specimen in a serpentine pattern between the primary and secondary scanning directions. Other scanning pattern is feasible in the present invention, as long as the largest surface area of the tissue specimen can be scanned. A larger image height can be adopted to accommodate rough tissues with large surface irregularities such as hepatectomy and lobectomy specimens. In certain embodiments, each of the two adjacent stripes of raw image data has about 10% overlapping region with each other. The multiple stripes of raw image data are stored in a memory of the present system or a workstation separately for subsequent image processing and stitching to form large field-of-views (FOVs). The stored raw image data are then loaded as a stack (data volume) into an image processing module with different plugins to reconstruct the tissue geometry from the raw data volume and extract surface features from the large FOVs after stitching the multiple image stripes (807). In certain embodiments, the image processing module is MATLAB-Fiji interface incorporated with multiple plugins (algorithms) for shearing the raw data volume initially recorded at 45° with respect to the tissue surface (e.g., x-z plane as in FIG. 1C) to form a trapezoidal data volume in order to correct image distortions arising from the raw image data obtained at 45° detection angle, for stitching multiple image stripes of raw data to form the large FOVs, and for determining spatial distribution of cell nuclei by extracting nuclear features from the stitched image, training a deep learning model. The reconstructed tissue image can be directly outputted for interpretation of the state of the tissue specimen by the medical practitioners or surgeons (808), or compared with a corresponding H&E-stained image (809) before being interpreted by the medical practitioners or surgeons. In certain embodiments, the deep learning model can generate pseudo-histochemically stained MUSI images to aid the interpretation of the state of the tissue specimen by the medical practitioners or surgeons for making intraoperative decision or post-operative clinical assessment.

Although the invention has been described in terms of certain embodiments, other embodiments apparent to those of ordinary skill in the art are also within the scope of this invention. Accordingly, the scope of the invention is intended to be defined only by the claims which follow.

### INDUSTRIAL APPLICABILITY

The present invention provides a platform and imaging method for freshly excised and living intact tissue surface in a label-free and non-destructive manner, holding a great potential as next-generation clinical standard method and intraoperative diagnostic tool which can provide real-time guidance to surgeons or pathologists to make clinical or medical decision such as removal of suspicious tumor during cancer surgeries. Taking advantage of the combination of the MUSI and autofluorescence spectroscopy to facilitate in vivo characterization of functional, structural and/or metabolic changes in tissues of interest can increase accuracy and specificity of this label-free and non-destructive imaging method. Incorporation of deep learning neural network and model in identifying the presence and spatial distribution of different microarchitectures in the tissues of interest also facilitates interpretation of the state of the tissues by pathologists with respect to disease prognosis.

1. An imaging system comprising:
a movable specimen-holding platform comprising a specimen holder and a liquid holder, the liquid holder having a prism-like structure;
a deep-UV excitation source providing deep-UV illuminations;
a first plurality of optical elements for generating a light sheet from the deep-UV illuminations provided by the deep-UV excitation source and directing the light sheet towards a bottom side of the specimen holder in order to illuminate on a bottom surface of the specimen at an incidence angle with respect to a vertical axis of the specimen holder through one of lateral faces of the prism-like structure of the at least one surface of the liquid holder;
a second plurality of optical elements for receiving light emissions including emitted fluorescence signals from the specimen under an excitation by the light sheet at a detection angle with respect to the vertical axis of the specimen holder and receiving light emissions; and
an optical detection unit for detecting and processing the received light emissions by the second plurality of optical elements,
wherein the incidence angle and the detection angle are substantially identical in magnitude and a beam path of the light sheet is substantially perpendicular to that of the light emissions from the specimen.

2. (canceled)

3. The imaging system of claim 1, wherein the movable specimen-holding platform is connected to a three-dimensional (3D) translational stage.

4. The imaging system of claim 1, wherein at least one surface of the specimen holder comprises a membrane to support the sample.

5. (canceled)

6. The imaging system of claim 1, wherein the first plurality of optical elements comprises a first filter, a pair of lenses, a slit aperture, and a cylindrical lens.

7. The imaging system of claim 6, wherein the first filter is a bandpass filter.

8. The imaging system of claim 6, wherein the pair of lenses is a pair of UV-grade convex lenses.

9. The imaging system of claim 6, wherein the slit aperture is an adjustable slit aperture.

10. The imaging system of claim 6, wherein the cylindrical lens is an UV cylindrical lens for generating a Gaussian light sheet.

11. The imaging system of claim 1, wherein the incidence angle of the light sheet illuminated on the bottom surface of the specimen is 45° with respect to the vertical axis of the specimen holder and the light sheet has an average energy fluence in compliance with a safety UV radiation threshold regulated by American Conference of Governmental Industrial Hygienists.

12. The imaging system of claim 1, wherein the liquid holder is disposed beneath the specimen holder in the movable specimen-holding platform.

13. The imaging system of claim 1, wherein the specimen is supported by a UV-transparent membrane being secured at a base of the specimen holder such that the light sheet is capable to reach the bottom surface of the specimen held in the specimen holder.

14. (canceled)

15. The imaging system of claim 1, wherein the prism-like structure of the movable specimen-holding platform comprises at least two UV-transparent windows disposed at two opposing lateral faces of the prism-like structure each allowing for the light sheet generated from the deep-UV excitation source to enter into or the light emissions including emitted fluorescence signals from the specimen after excitation by the light sheet to leave the movable specimen-holding platform.

16. (canceled)

17. (canceled)

18. The imaging system of claim 1, wherein, the second plurality of optical elements includes at least an UV objective lens, a second filter, and an infinity-corrected lens.

19. The imaging system of claim 18, wherein the UV objective lens is an achromatic UV objective lens.

20. The imaging system of claim 18, wherein the second filter is a long pass filter.

21. The imaging system of claim 18, wherein the infinity-corrected lens is an infinity-corrected tube lens.

22. (canceled)

23. (canceled)

24. A method for imaging a biological tissue in a label-free, unprocessed manner comprising using the imaging system of claim 1 to output histology-like images showing two-dimensional or three-dimensional profile of the biological tissue, wherein said using the imaging system of claim 1 to output the histology-like images showing the two-dimensional or three-dimensional profile of the biological tissue comprises the following steps:
(a) placing the biological tissue into the specimen holder of the movable specimen-holding platform of the imaging system where a relatively flatter side of the biological tissue faces a UV-transparent membrane disposed at the bottom of the specimen holder;
(b) immersing the specimen holder held with the biological tissue into the liquid holder of the movable specimen-holding platform filled with a liquid;
(c) adjusting one or more of the first plurality of optical elements for directing light sheet generated thereby on the bottom surface of the specimen at an incidence angle of 45° with respect to the vertical axis of the specimen holder, or with an incident beam path of the light sheet being substantially perpendicular to an UV-transparent window on one lateral face of the prism-like structure at the bottom of the liquid holder;
(d) adjusting one or more of the second plurality of optical elements for receiving light emissions including fluorescence signals emitted from the specimen at a detection angle of 45° with respect to the vertical axis of the specimen holder or being orthogonal to the incident beam path of the light sheet;
(e) initiating the deep-UV excitation source to generate UV illuminations towards the first plurality of optical elements followed by modulation of the UV illuminations by the first plurality of optical elements to generate and direct the light sheet towards a first spot of the specimen through one of the UV-transparent windows of the prism-like structure at the bottom of the liquid holder at the incidence angle of 45° with respect to the vertical axis of the specimen holder;
(f) receiving the light emissions including emitted fluorescence signals from the specimen excited by the light sheet through the second plurality of optical elements;
(g) detecting the received light emissions including emitted fluorescence signals from the second plurality of optical elements by the optical detection unit including the plurality of CMOS image sensors;
(h) moving the movable specimen-holding platform driven by the 3D translational stage towards a primary scanning direction from the first spot to a subsequent spot of the specimen on the same plane and repeating the steps (e) to (g) in each of the subsequent spots until reaching the last spot on the same plane in the primary scanning direction, forming a first image stripe;
(i) moving the movable specimen-holding platform towards a secondary scanning direction laterally relative to the first scanning direction and repeating steps (e) to (h) to form a subsequent image stripe adjacent to the first image stripe until the whole largest surface area of the biological tissue is scanned; and
(j) processing the image data detected by the optical detection unit to reconstruct geometry of the biological tissue through an image processing module and outputting one or more images representing an overall geometry of the biological tissue after reconstruction.

25. (canceled)

26. (canceled)

27. The method of claim 24, wherein following formation of a first image stripe along the primary scanning direction, the movable specimen-holding platform is moved laterally relative to the primary scanning direction towards the secondary scanning direction such that a subsequent image stripe is formed along the primary scanning direction adjacent to the first image stripe, wherein a movement path of the movable specimen-holding platform for covering the whole largest surface area of the biological specimen is in serpentine or spiral centering pattern.

28. (canceled)

29. The method of claim 24, wherein distortion in raw images of the image stripes due to the detection angle unparallel to the vertical axis of the specimen holder is corrected by one of the image processing algorithms.

30. The method of claim 24, wherein at least surface features in the detected image data are extracted by the other image processing algorithm until all the image stripes are processed.
